(19) United States
(12) Patent Application Publication
(10) Pub. No.: US 2024/0153297 A1
(43) Pub. Date: May 9, 2024

(54) ZERO-SHOT FORM ENTITY QUERY FRAMEWORK

(71) Applicant: Google LLC, Mountain View, CA (US)

(72) Inventors: Zizhao Zhang, San Jose, CA (US); Zifeng Wang, Mountain View, CA (US); Vincent Perot, Brooklyn, NY (US); Jacob Devlin, Mountain View, CA (US); Chen-Yu Lee, Mountain View, CA (US); Guolong Su, State College, PA (US); Hao Zhang, Jericho, NY (US); Tomas Jon Pfister, Foster City, CA (US)

(73) Assignee: Google LLC, Mountain View, CA (US)

(21) Appl. No.: 18/501,982

(22) Filed: Nov. 3, 2023

Related U.S. Application Data
(60) Provisional application No. 63/382,593, filed on Nov. 7, 2022.

(51) Int. Cl. G06V 30/24; G06F 16/21; G06V 30/19; G06V 30/412

(52) U.S. Cl. CPC G06V 30/24; G06F 16/211; G06V 30/19147; G06V 30/412

(57) ABSTRACT

A method for extracting entities comprises obtaining a document that includes a series of textual fields that includes a plurality of entities. Each entity represents information associated with a predefined category. The method includes generating, using the document, a series of tokens representing the series of textual fields. The method includes generating an entity prompt that includes the series of tokens and one of the plurality of entities and generating a schema prompt that includes a schema associated with the document. The method includes generating a model query that includes the entity prompt and the schema prompt and determining, using an entity extraction model and the model query, a location of the one of the plurality of entities among the series of tokens. The method includes extracting, from the document, the one of the plurality of entities using the location of the one of the plurality of entities.

### CROSS REFERENCE TO RELATED APPLICATIONS

This U.S. patent application claims priority under 35 U.S.C. § 119(e) to U.S. Provisional Application 63/382,593, filed on Nov. 7, 2022. The disclosure of this prior application is considered part of the disclosure of this application and is hereby incorporated by reference in its entirety.

### TECHNICAL FIELD

This disclosure relates to zero-shot form entity query frameworks.

### BACKGROUND

Entity extraction is a popular technique that identifies and extracts key information from text. Entity extraction tools may classify the information into predefined categories which converts previously unstructured data into structured data that downstream applications may use in any number of ways. For example, entity extraction tools may process unstructured data to extract data from documents or forms to automate many data entry tasks. Automatically extracting and organizing structured information from form-like documents is a valuable yet challenging problem.

### SUMMARY

One aspect of the disclosure provides a method for extracting entities from documents. The computer-implemented method, when executed by data processing hardware, causes the data processing hardware to perform operations. The operations include obtaining a document that includes a series of textual fields. The series of textual fields includes a plurality of entities and each entity of the plurality of entities represents information associated with a predefined category. The operations include generating, using the document, a series of tokens representing the series of textual fields. The operations also include generating an entity prompt that includes the series of tokens and one of the plurality of entities and generating a schema prompt that includes a schema associated with the document. The operations include generating a model query that includes the entity prompt and the schema prompt. The operations include determining, using an entity extraction model and the model query, a location of the one of the plurality of entities among the series of tokens. The operations also include extracting, from the document, the one of the plurality of entities using the location of the one of the plurality of entities.

Implementations of the disclosure may include one or more of the following optional features. In some implementations, the operations further include, prior to determining the location of the one of the plurality of entities among the series of tokens, pre-training the entity extraction model using generalized training samples and, after pre-training the entity extraction model, fine-turning the entity extraction model using a plurality of training documents. In some of these implementations, the generalized training samples include data from public websites. Each respective training sample may include a respective training entity prompt associated with a respective public website and a respective training schema prompt associated with the respective public website. Optionally, each respective training entity prompt includes an HTML, tag of the respective public website and each respective training schema prompt includes a domain of the respective public website. In some examples, the operations further include extracting, from the public websites, entity data and schema data; generating, from the entity data, each respective training entity prompt; and generating, from the schema data, each respective training schema prompt. The generalized training samples may not be human annotated and the plurality of training documents may be human annotated.

In some examples, the entity extraction model includes a zero-shot machine learning model. Generating the series of tokens representing the series of textual fields may include determining the series of tokens using an optical character recognition (OCR) model. Optionally, the operations further include, determining, using the location of the one of the plurality of entities, a value associated with the one of the plurality of entities.

Another aspect of the disclosure provides a system for extracting entities from documents. The system includes data processing hardware and memory hardware in communication with the data processing hardware. The memory hardware stores instructions that when executed on the data processing hardware cause the data processing hardware to perform operations. The operations include obtaining a document that includes a series of textual fields. The series of textual fields includes a plurality of entities and each entity of the plurality of entities represents information associated with a predefined category. The operations include generating, using the document, a series of tokens representing the series of textual fields. The operations also include generating an entity prompt that includes the series of tokens and one of the plurality of entities and generating a schema prompt that includes a schema associated with the document. The operations include generating a model query that includes the entity prompt and the schema prompt. The operations include determining, using an entity extraction model and the model query, a location of the one of the plurality of entities among the series of tokens. The operations also include extracting, from the document, the one of the plurality of entities using the location of the one of the plurality of entities.

This aspect may include one or more of the following optional features. In some implementations, the operations further include, prior to determining the location of the one of the plurality of entities among the series of tokens, pre-training the entity extraction model using generalized training samples and, after pre-training the entity extraction model, fine-turning the entity extraction model using a plurality of training documents. In some of these implementations, the generalized training samples include data from public websites. Each respective training sample may include a respective training entity prompt associated with a respective public website and a respective training schema prompt associated with the respective public website. Optionally, each respective training entity prompt includes an HTML tag of the respective public web site and each respective training schema prompt includes a domain of the respective public website. In some examples, the operations further include extracting, from the public web sites, entity data and schema data; generating, from the entity data, each respective training entity prompt; and generating, from the schema data, each respective training schema prompt. The generalized training samples may not be human annotated and the plurality of training documents may be human annotated.

In some examples, the entity extraction model includes a zero-shot machine learning model. Generating the series of tokens representing the series of textual fields may include determining the series of tokens using an optical character recognition (OCR) model. Optionally, the operations further include, determining, using the location of the one of the plurality of entities, a value associated with the one of the plurality of entities.

Another aspect of the disclosure provides a user. The user device includes a display and data processing hardware in communication with the display. The user device also includes memory hardware in communication with the data processing hardware. The memory hardware stores instructions that when executed on the data processing hardware cause the data processing hardware to perform operations. The operations include obtaining a document that includes a series of textual fields. The series of textual fields includes a plurality of entities and each entity of the plurality of entities represents information associated with a predefined category. The operations include generating, using the document, a series of tokens representing the series of textual fields. The operations also include generating an entity prompt that includes the series of tokens and one of the plurality of entities and generating a schema prompt that includes a schema associated with the document. The operations include generating a model query that includes the entity prompt and the schema prompt. The operations include determining, using an entity extraction model and the model query, a location of the one of the plurality of entities among the series of tokens. The operations also include extracting, from the document, the one of the plurality of entities using the location of the one of the plurality of entities.

Implementations of the disclosure may include one or more of the following optional features. In some implementations, the operations further include, prior to determining the location of the one of the plurality of entities among the series of tokens, pre-training the entity extraction model using generalized training samples and, after pre-training the entity extraction model, fine-turning the entity extraction model using a plurality of training documents. In some of these implementations, the generalized training samples include data from public websites. Each respective training sample may include a respective training entity prompt associated with a respective public website and a respective training schema prompt associated with the respective public website.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for extracting entities.

FIG. 2 is a schematic view of example textual fields of a document.

FIG. 3 is a schematic view of exemplary components of the system of FIG. 1.

FIG. 4 is a schematic view of pre-training for a model of the system of FIG. 1.

FIG. 5 is a schematic view of fine-tuning for a model of the system of FIG. 1.

FIG. 6 is a schematic view of zero-shot learning for a model of the system of FIG. 1.

FIG. 7 a flowchart of an example arrangement of operations for a method of extracting entities from a document.

FIG. 8 is a schematic view of an example computing device that may be used to implement the systems and methods described herein.

Like reference symbols in the various drawings indicate like elements.

### DETAILED DESCRIPTION

Entity extraction is a popular technique that identifies and extracts key information from text. Entity extraction tools may classify the information into predefined categories which converts previously unstructured data into structured data that downstream applications may use in any number of ways. For example, entity extraction tools may process unstructured data to extract data from documents or forms to automate many data entry tasks.

Form-like document understanding has become a booming research topic recently motivated by real-world applications in industry. Form-like documents refer to documents with rich typesetting formats such as invoices, receipts, etc. Automatically extracting and organizing structured information from form-like documents is a valuable yet challenging problem. However, in real-world scenarios, the need for generalizing models to new documents with various schemas is unrealistic. Beyond annotation costs, endlessly training specialized models on new types of documents is not scalable.

Some known techniques treat entities of a certain document type simply as discrete classes via supervised classification training. The set of predetermined entities define the schema of this document type (i.e., the classification classes). As a result, these techniques not only require annotated training data for the target schema, but also are limited to the target schema with unsatisfying generalization ability. However, the cost of manually labeling form-like documents with high accuracy is significantly high and quickly becomes a bottleneck for enterprise usage. For example, when a schema needs changes or updates, annotations of corresponding documents must be revisited.

Thus, it is desirable to have a systematic way to learn knowledge from various types of existing annotated documents to the unannotated target document. For example, it is advantageous to pre-train and fine-tune a model from various types of documents so that the model may generalize well to unseen invoice documents. This learning paradigm may be referred to as zero-shot transfer learning.

Implementations herein include a document entity extractor for providing a query-based framework for extracting entities from forms and documents. The document entity extractor extracts entities in a zero-shot fashion using a bi-level prompting mechanism that encodes document schema and entity into queries for an entity extraction model (e.g., a transformer architecture) to make conditional predictions. The bi-level prompting enables the model (i.e., the neural network) to learn from arbitrary documents containing varying numbers of entities and to effectively generalize on target document types. A model trainer may pre-train the entity extraction model on large-scale form-like web pages using, for example, HTML annotations.

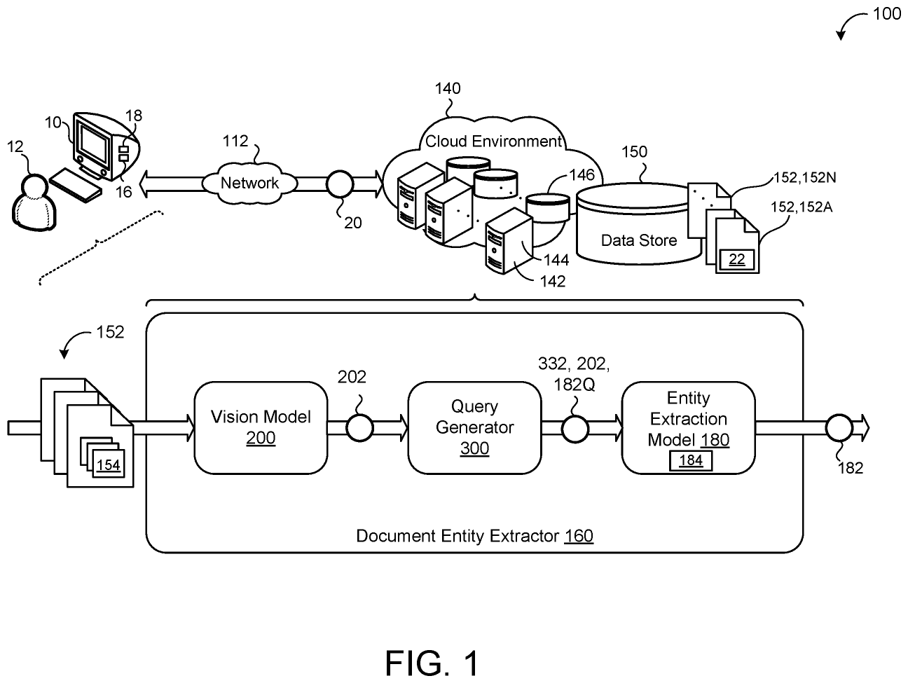

Referring to FIG. 1, in some implementations, an example document entity extraction system 100 includes a remote system 140 in communication with one or more user devices 10 via a network 112. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 150 (i.e., a remote storage device) may be overlain on the storage resources 146 to allow scalable use of the storage resources 146 by one or more of the clients (e.g., the user device 10) or the computing resources 144. The data store 150 is configured to store a set of documents 152, 152a-n. The documents 152 may be of any type and from any source (e.g., from the user 12, other remote entities, or generated by the remote system 140). For example, the documents 152 are forms, or other form-like entities. Each document is associated with a schema 22 that defines the structure for a document type of the document 152 (e.g., an invoice or a paystub).

The remote system 140 is configured to receive an entity extraction request 20 from a user device 10 associated with a respective user 12 via, for example, the network 112. The user device 10 may correspond to any computing device, such as a desktop workstation, a laptop workstation, or a mobile device (i.e., a smart phone). The user device 10 includes computing resources 18 (e.g., data processing hardware) and/or storage resources 16 (e.g., memory hardware). The request 20 may include one or more documents 152 for entity extraction. Additionally or alternatively, the request 20 may refer to one or more documents 152 stored at the data store 150 for entity extraction.

The remote system 140 may execute a document entity extractor 160 for extracting structured entities 182 from the documents 152. The entities 182 represent information (e.g., values) extracted from the document that has been classified into or associated with a predefined category. In some examples, each entity 182 includes a key-value pair, where the key is the classification and the value represents the value extracted from the document 152. For example, an entity 182 extracted from a form (e.g., document 152) includes a key (or label or classification) of “name” and a value of “Jane Smith” which may be classified into the category “identification.” As another example, an entity 182 extracted from a form includes a key of “city” and a value of “Chicago” which may be classified into the category of “location.”

The remote system 140 may execute the document entity extractor 160 in its entirety. In other examples, the user device 10 executes the document entity extractor 160 (i.e., using the computing resources 18 and the storage resources 16. In yet other examples, a portion of the document entity extractor 160 executes on the remote system 140 while a different portion (e.g., a graphical user interface, a document 152 collector, etc.) executes on the user device 10. The document entity extractor 160 receives the documents 152 (e.g., from the user device 10 and/or the data store 150). The document entity extractor 160 includes a vision model 200.

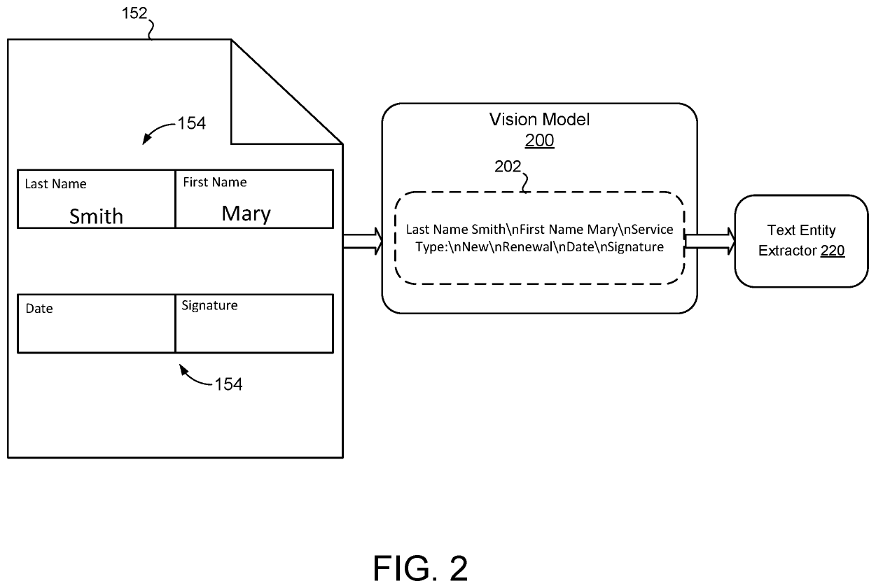

Referring now to FIG. 2, each document 152 received by the document entity extractor 160 includes a series of textual fields 154. In some examples, the vision model 200, for each respective textual field 154 of the document 152, determines a respective textual offset for the respective textual field 154. The textual offset indicates a location of the respective textual field 154 relative to each other textual field 154 in the document 152. The vision model 200 may include a tokenizer for tokenizing the textual fields 154. For example, a tokenization of the document 152 includes the textual offsets represented by a position within an array (e.g., a two-dimensional or three-dimensional array). The vision model 200 may employ techniques such as optical character recognition (OCR) (e.g., the vision model 200 may include an OCR model) to extract/tokenize the textual fields 154.

Here, an example document 152 is a form with a textual field 154 for a “Last Name” that has been filled with “Smith,” a textual field 154 for a “First Name” filled with “Mary,” and blank “Date” and “Signature” textual fields 154. Using conventional extraction systems (e.g., OCR capabilities), the vision model 200, as shown in this example, extracts a series of tokens 202 (e.g., a text span or the like) that represents text from the textual fields 154. The series of tokens 202 provides an order to the textual fields 154 of the document 152.

Referring back to FIG. 1, the information of the series of tokens 202 (e.g., the relative location of textual fields 154 relative to other textual fields 154 of the document 152) may be provided to a query generator 300 included in the document entity extractor 160. The query generator 300 generates extraction queries 332 for querying an entity extraction model 180. The extraction queries 332 ask the entity extraction model 180 to determine a location of one or more specific entities 182 within one or more documents 152 (i.e., within the series of tokens 202 or text span) specified by the entity extraction request 20.

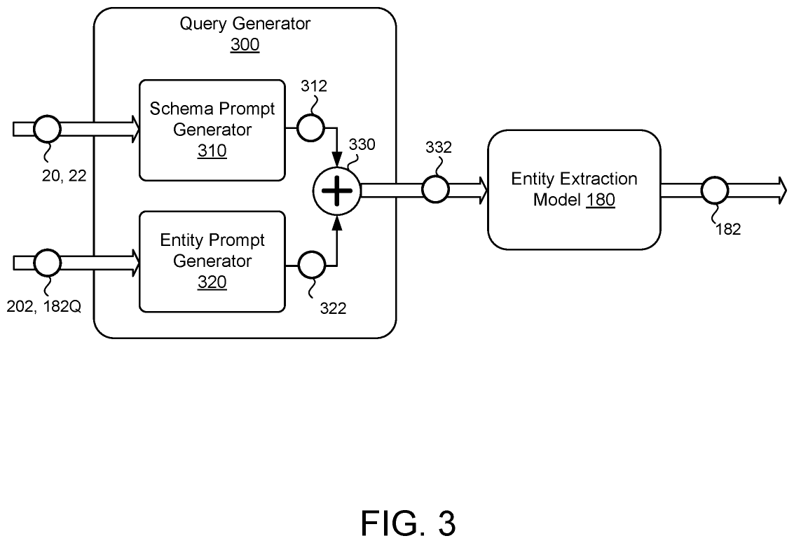

Referring now to FIG. 3, in some examples the query generator 300 includes a schema prompt generator 310 and an entity prompt generator 320. The entity prompt generator 320 generates an entity prompt 322 that includes the series of tokens 202 of the respective document 152 and a query entity 182, 182Q. The query entity 182Q includes one or more entities 182 to query the entity extraction model 180 to extract from the series of tokens 202. For example, the query entity 182Q may represent an entity 182 associated with a “name” field of the respective document 152 (e.g., a form that includes a field for a name of the person filling out the form), which in turns instructs the entity extraction model 180 to determine the location of the “name” entity 182 in the respective document 152 such that the value associated with the “name” entity 182 may be extracted (e.g., “Jane Smith”). The entity prompt 322 encodes the query entity 182Q information. As discussed in more detail below, the schema prompt generator 310 also generates a schema prompt 312 based on a schema 22 associated with the respective document(s) 152 of the query entity 182Q. The schema 22 identifies a quantity of entities 182 present in the respective document 152. That is, the schema prompt 312 encodes the schema information associated with the document 152 of the query entity 182Q.

The query generator 300 generates a model query 332 that includes the schema prompt 312 and the entity prompt 322. For example, the query generator 300 includes an aggregator 330 that aggregates or combines the schema prompt 312 and the entity prompt 322 into the query prompt 332 (i.e., a bi-level prompt). The query generator 300 queries the entity extraction model 180 using the query prompt 332. Thus, the query prompt 332 encodes both entity and schema information for the entity extraction model 180. In essence, the query prompt 332 queries the entity extraction model 180 with a form that may be interpreted as “the respective document 154 has the following [schema 22], extract the [entity 182Q] value.” Based on the query prompt 332, the entity extraction model 180 determines the location of the query entity 182Q and extracts, from the document 152 at the determined location, the query entity 182Q (i.e., the value of the query entity 182Q).

Referring back to FIG. 1, the entity extraction model 180, in some examples, and in response to the query prompt 332, predicts the corresponding word tokens that belong to the query entity 182Q. For example, the entity extraction model 180 predicts a start point and an end point in the series of tokens 202 that correspond to the value of the query entity 182Q. The start point and the end point define a location 184 of the query entity 182Q within the series of tokens 202. Using the location 184, the document entity extractor may determine the value associated with the query entity 182Q. The query generator 300 may generate any number of query prompts 332 (i.e., bi-level prompts) to extract any or all of the query entities 182Q (and the corresponding values) from the respective document 152 and return the extracted entities 182 or values to the user 12, store the extracted entities 182 at the data store 150, and/or use the extracted entities 182 for further downstream processing.

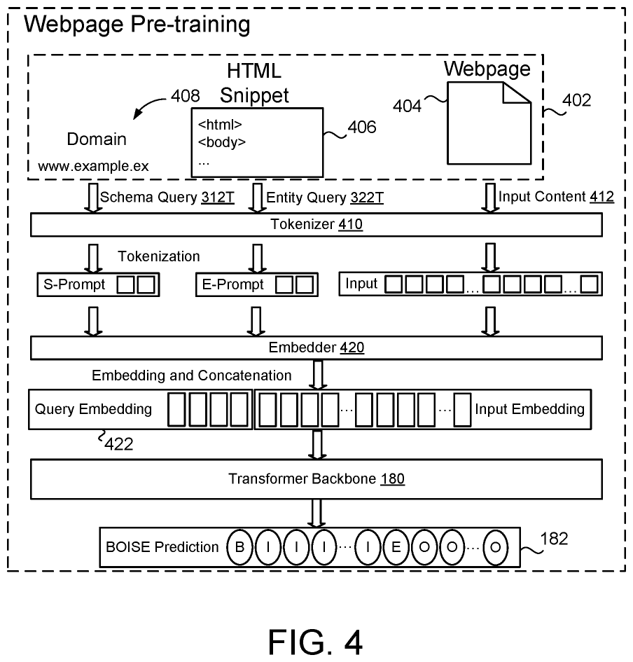

Referring now to FIG. 4, in some implementations, the document entity extractor 160 pre-trains the entity extraction model 180 using generalized training samples 402. In some implementations, the generalized training samples 402 include entity data and schema data extracted from public web sites (e.g., obtained or accessed via a web scraper or the like) such as web page content 404 of the web site, HTML snippets 406 (i.e., portions of the HTML code that make up the website), and/or domain information 408 of the website. Each training sample 402 in a set of generalized training samples 402 may include a respective training entity prompt 322T (or a training entity query) associated or generated from the entity data (e.g., a respective public web site) and a respective training schema prompt 312T (or training schema query) associated with or generated from the schema data (e.g., the respective website). For example, each respective training entity prompt 322T includes one or more HTML tags 406 of the respective public website and each respective training schema prompt includes a domain 408 of the respective public website. This allows the document entity extractor 160 to leverage a highly-accessible and nearly inexhaustible training resource. Additionally, public web pages ideally align with the query prompt 332. A web page scraper or extractor may extract HTML tags from web pages to form the training entity prompts 322T and the domain 408 of the web page may serve as the basis for the schema of the training schema prompt 312T. In this way, the generalized training samples 402 do not include any human annotations, allowing for cost-effective generation of a large collection of training samples 402 for the entity extraction model 180.

Optionally, the web page pre-training includes a tokenizer 410 that tokenizes the schema prompt 312T, the entity prompt 322T, and input content 412 derived from the web page 404. The tokenized information may be provided to an embedder 420 that embeds and concatenates the tokenized schema prompt 312T, the entity prompt 322T, and the input content 412 into a query embedding 422. The entity extraction model 180 (i.e., a transformer backbone) uses the query embedding 422 to generate predictions (e.g., the location 184 of the entity 182) via, for example, a BOISE scheme.

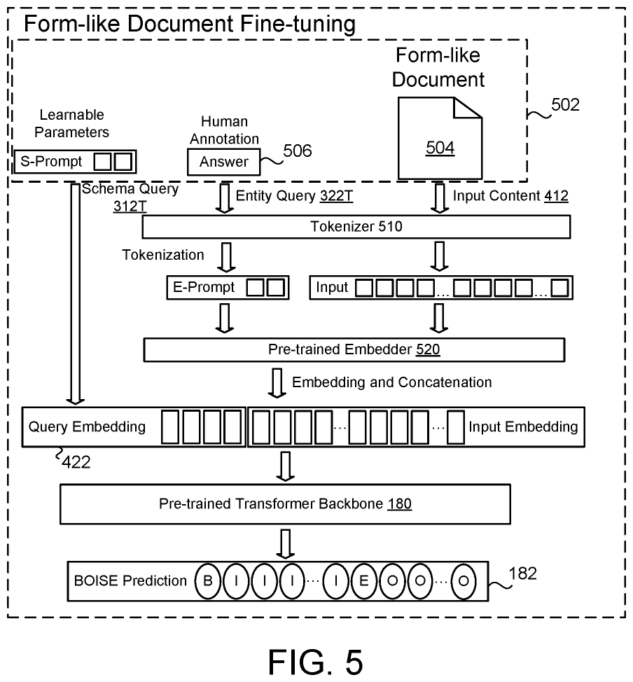

Referring now to FIG. 5, in some implementations, the document entity extractor 160, after pre-training the entity extraction model 180 (e.g., on a large quantity of generalized training samples 402 automatically generated from public websites), fine-tunes the entity extraction model 180 using annotated training samples 501 generated from a set of training documents 504. The set of training documents includes a relatively small number of documents that are human-annotated with annotations 506 (i.e., a much smaller quantity than a quantity of the generalized training samples 402 which are not human-annotated). The training documents 504 include many different types of form-like documents so that the entity extraction model 180 may learn more specialized knowledge based on information learned from the training entity prompts 322T and the training schema prompts 312T. In general, the plurality of training documents 504 are closer to the target dataset (i.e., the documents 152 supplied by the user 12 during inference) than the generalized training samples 402. Notably, however, the training documents 504 do not need to be the same as the actual documents 152 provided during inference (e.g., not the same forms). Instead, in some examples, the entity extraction model 180 includes a zero-shot machine learning model that uses zero-shot transfer learning principles to extract entities 182 from documents 152 with schemas 22 the entity extraction model 180 did not train on.

During the pre-training phase (FIG. 4), schema information (encoded within the training schema prompts 312T) is generally highly abstract and not readily available from the dataset. Importantly, the datasets used during the fine-tuning stage (FIG. 5) are closer to the target dataset in format (e.g., both are more form-like), thus the schema prompt 312 is learnable during fine-turning to capture schema information implicitly from the data. Because learned schema prompts 312T reside in a continuous embedding space, the schema prompts 312T are concatenated after embedding instead of at the token level. For this reason, in this example, the training entity prompt 322T and input content 412 are tokenized and embedded using a pre-trained embedder 520 separate from the training schema prompt 412T.

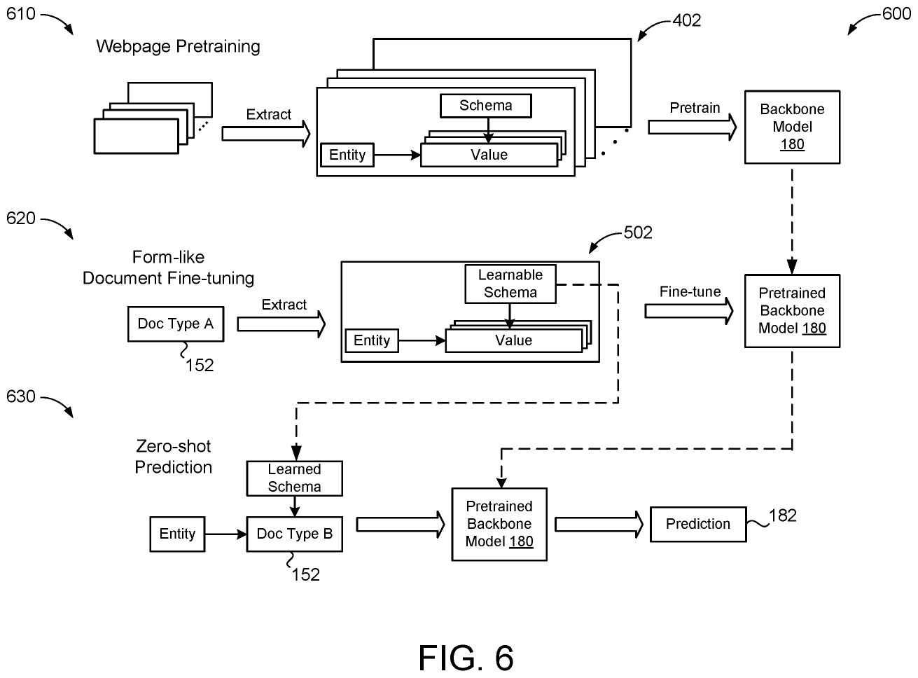

Referring now to FIG. 6, a schematic view 600 illustrates exemplary zero-shot transfer learning stages of the entity extraction model 180. Here, in the pre-training stage 610, the document entity extractor 160 may extract many (e.g., millions) schemas and entity-value pairs from public available web pages to generate a large amount of query-value pairs to familiarize the backbone entity extraction model 180 with query-conditioned predictions. During a fine-tuning stage 620, the document entity extractor 160 extracts more accurate entity-value pairs from available training documents (i.e., human-annotated documents) to directly learn schema information. During a zero-shot prediction 630 stage, the pre-trained and fine-tuned entity extraction model 180 uses zero-shot learning techniques to extract entities 182 from documents 152 of types not trained on in either the pre-training phase 610 or the fine-tuning phase 602.

Thus, the document entity extractor 160 provides a query-based framework for zero-shot document entity extraction. The document entity extractor 160 employs a bi-level prompting mechanism to encode document schema and entity information to learn transferable knowledge from source to target document types. Optionally, the document entity extractor 160 includes an entity extraction model 180 that is pre-trained using publicly available web pages with various layouts and HTML, annotations. Although web pages tend to show a high discrepancy from common entity extraction targets (e.g., forms), the web pages consistently improve zero-shot performance because of the large amount of schemas and entity query-value pairs that can be cheaply generated.

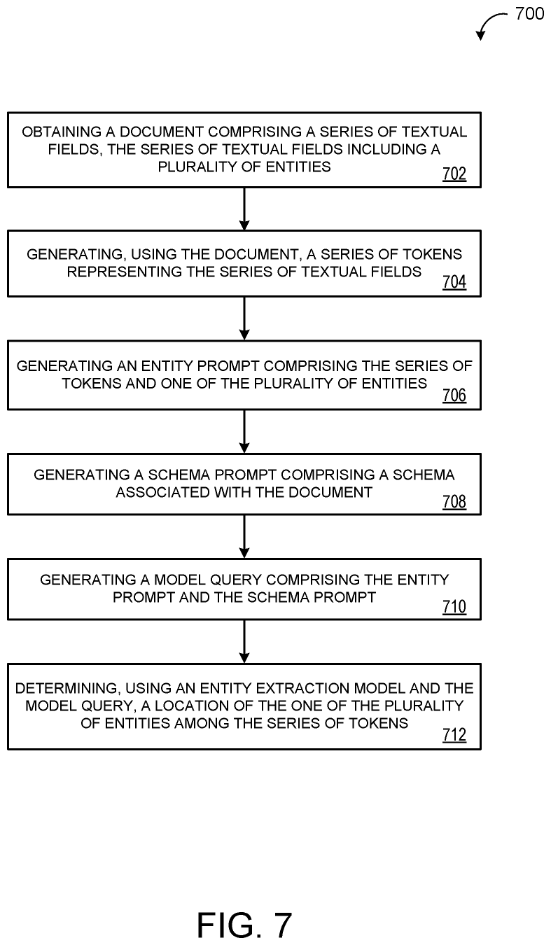

FIG. 7 is a flowchart of an exemplary arrangement of operations for a method 700 for extracting entities from a document. The method 700, at operation 702, includes obtaining a document 152 including a series of textual fields 154. The series of textual fields 154 include a plurality of entities 182. The method 700, at operation 704, includes generating, using the document 152, a series of tokens 202 representing the series of textual fields 154. At operation 706, the method 700 includes generating an entity prompt 322 including the series of tokens 202 and one of the plurality of entities 182. At operation 708, the method 700 includes generating a schema prompt 312 including a schema 22 associated with the document 152. The method 700, at operation 710, includes generating a model query 332 (i.e., a bi-level prompt 332) that includes the entity prompt 322 and the schema prompt 312. At operation 712, the method 700 includes determining, using an entity extraction model 180 and the model query 332, a location of the one of the plurality of entities 182 among the series of tokens 202.

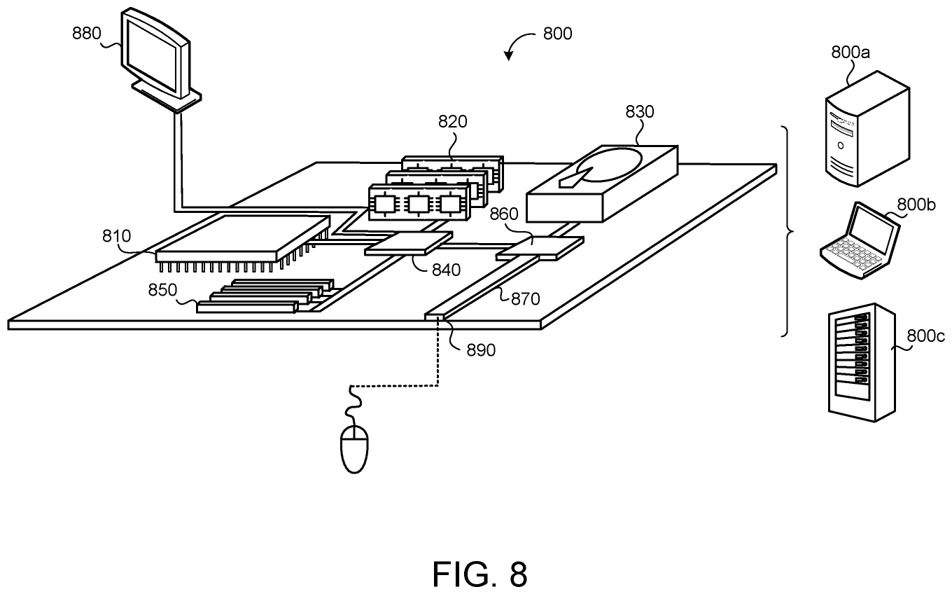

FIG. 8 is a schematic view of an example computing device 800 that may be used to implement the systems and methods described in this document. The computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low speed interface/controller 860 connecting to a low speed bus 870 and a storage device 830. Each of the components 810, 820, 830, 840, 850, and 860, are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 820, the storage device 830, or memory on processor 810.

The high speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and a low-speed expansion port 890. The low-speed expansion port 890, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
obtaining a document comprising a series of textual fields, the series of textual fields comprising a plurality of entities, each entity of the plurality of entities representing information associated with a predefined category;
generating, using the document, a series of tokens representing the series of textual fields;
generating an entity prompt comprising the series of tokens and one of the plurality of entities;
generating a schema prompt comprising a schema associated with the document;
generating a model query comprising the entity prompt and the schema prompt;
determining, using an entity extraction model and the model query, a location of the one of the plurality of entities among the series of tokens; and
extracting, from the document, the one of the plurality of entities using the location of the one of the plurality of entities.

2. The method of claim 1, wherein the operations further comprise, prior to determining the location of the one of the plurality of entities among the series of tokens:
pre-training the entity extraction model using generalized training samples; and
after pre-training the entity extraction model, fine-turning the entity extraction model using a plurality of training documents.

3. The method of claim 2, wherein the generalized training samples comprise data from public web sites.

4. The method of claim 3, wherein each respective generalized training sample comprises:
a respective training entity prompt associated with a respective public website; and
a respective training schema prompt associated with the respective public website.

5. The method of claim 4, wherein:
each respective training entity prompt comprises an HTML tag of the respective public website; and
each respective training schema prompt comprises a domain of the respective public website.

6. The method of claim 3, wherein the operations further comprise:
extracting, from the public websites, entity data and schema data;
generating, from the entity data, each respective training entity prompt; and
generating, from the schema data, each respective training schema prompt.

7. The method of claim 2, wherein:
the generalized training samples are not human annotated; and
the plurality of training documents are human annotated.

8. The method of claim 1, wherein the entity extraction model comprises a zero-shot machine learning model.

9. The method of claim 1, wherein generating the series of tokens representing the series of textual fields comprises determining the series of tokens using an optical character recognition (OCR) model.

10. The method of claim 1, where the operations further comprise, determining, using the location of the one of the plurality of entities, a value associated with the one of the plurality of entities.

11. A system comprising:
data processing hardware; and
memory hardware in communication with the data processing hardware, the memory hardware storing instructions that when executed on the data processing hardware cause the data processing hardware to perform operations comprising:
obtaining a document comprising a series of textual fields, the series of textual fields comprising a plurality of entities, each entity of the plurality of entities representing information associated with a predefined category;
generating, using the document, a series of tokens representing the series of textual fields;
generating an entity prompt comprising the series of tokens and one of the plurality of entities;
generating a schema prompt comprising a schema associated with the document;
generating a model query comprising the entity prompt and the schema prompt;
determining, using an entity extraction model and the model query, a location of the one of the plurality of entities among the series of tokens; and
extracting, from the document, the one of the plurality of entities using the location of the one of the plurality of entities.

12. The system of claim 11, wherein the operations further comprise, prior to determining the location of the one of the plurality of entities among the series of tokens:
pre-training the entity extraction model using generalized training samples; and
after pre-training the entity extraction model, fine-turning the entity extraction model using a plurality of training documents.

13. The system of claim 12, wherein the generalized training samples comprise data from public web sites.

14. The system of claim 13, wherein each respective generalized training sample comprises:
a respective training entity prompt associated with a respective public website; and
a respective training schema prompt associated with the respective public website.

15. The system of claim 14, wherein:
each respective training entity prompt comprises an HTML tag of the respective public website; and
each respective training schema prompt comprises a domain of the respective public website.

16. The system of claim 13, wherein the operations further comprise:
extracting, from the public websites, entity data and schema data;
generating, from the entity data, each respective training entity prompt; and
generating, from the schema data, each respective training schema prompt.

17. The system of claim 12, wherein:
the generalized training samples are not human annotated; and
the plurality of training documents are human annotated.

18. The system of claim 11, wherein the entity extraction model comprises a zero-shot machine learning model.

19. The system of claim 11, wherein generating the series of tokens representing the series of textual fields comprises determining the series of tokens using an optical character recognition (OCR) model.

20. The system of claim 11, where the operations further comprise, determining, using the location of the one of the plurality of entities, a value associated with the one of the plurality of entities.

21. A user device comprising:
a display;
data processing hardware in communication with the display; and
memory hardware in communication with the data processing hardware, the memory hardware storing instructions that when executed on the data processing hardware cause the data processing hardware to perform operations comprising:
obtaining a document comprising a series of textual fields, the series of textual fields comprising a plurality of entities, each entity of the plurality of entities representing information associated with a predefined category;
generating, using the document, a series of tokens representing the series of textual fields;
generating an entity prompt comprising the series of tokens and one of the plurality of entities;
generating a schema prompt comprising a schema associated with the document;
generating a model query comprising the entity prompt and the schema prompt;
determining, using an entity extraction model and the model query, a location of the one of the plurality of entities among the series of tokens; and
extracting, from the document, the one of the plurality of entities using the location of the one of the plurality of entities.

22. The user device of claim 21, wherein the operations further comprise, prior to determining the location of the one of the plurality of entities among the series of tokens:
pre-training the entity extraction model using generalized training samples; and
after pre-training the entity extraction model, fine-turning the entity extraction model using a plurality of training documents.

23. The user device of claim 22, wherein the generalized training samples comprise data from public websites.

24. The user device of claim 23, wherein each respective training sample comprises:
a respective training entity prompt associated with a respective public website; and
a respective training schema prompt associated with the respective public website.
